(19) United States
(12) Patent Application Publication
(10) Pub. No.: US 2006/0118181 A1
(43) Pub. Date: Jun. 8, 2006

(54) Automatic gas shut-off valve

(76) Inventor: Richard Benson Landon, Santa Cruz, CA (US)

Correspondence Address: RICHARD LANDON, 1787 BRANCIFORTE DRIVE, SANTA CRUZ, CA, 95065, US

(21) Appl. No.: 10/876,357

(22) Filed: Jun. 24, 2004

(51) Int. Cl. F16K 31/48

(52) U.S. Cl. 137/624.12

(57) ABSTRACT

A shut-off device, especially suitable for controlling gas flow to an apparatus, has a body attaching between a gas supply source and a gas powered appliance like a barbecue, with internal body bore passages between; a piston located and compressed in a bore by a spring against a stopper pin; the piston positioned over a gas nozzle configured inline with the bore passages to cut off gas flow when the stopper pin released the piston. A solenoid connects to the stopper pin is electrically activated by a timer, a pressure sensor, and a timer selector, powered a battery. A manual reset button provides re-activation of the invention once tripped, allows gas flow.

### FIELD OF THE INVENTION

The invention as disclosed here within consists of a shutoff valve for the control of gas or liquid to an appliance. The valve automatically controls the flow of gas to the appliance over a fixed or variable duration of time. A typical application positions the shutoff valve in a supply line to a cooking device or any other gas appliance that is typically manually regulated and requiring safety or conservation procedures.

### BACKGROUND OF THE INVENTION

In a typical scenario many homeowners have gas grills outside, and from time to time, will leave the grill on accidentally or on purpose to burn excess fat. Once returning inside their homes for dinner they then forget to turn off their grill until reuse. Many times an entire propane tank will be emptied equivalent to many dollars of fuel wasted. In their haste, many users of gas grills will find that the next time they want to use their grill there is no gas in the tank. Gas grills come in many configurations and are popular. The number of gas grills currently in use is very large. The monetary savings on lost fuel would be great if those grills had a non-operator way of turning off fuel. There may even be times when grills are placed near buildings or other flammable materials and once forgotten, heat up and start dangerous fires. What is needed is a low cost accessory device (an automatic shutoff valve, as in the spirit of this invention) to conserve fuel while assuring a level of safety. This accessory shut-off valve would be easily installed and configured to any common gas grill connecting directly to a typical propane tank. In an alternatively configuration, the automatic shut-off valve is part of the propane tank control valve assembly. Furthermore, what is needed in the spirit of forgetfulness, the automatic shut off valve works in the background, not requiring any adjustments or pre-set maintenance, ensuring conservation of propane fuel and safety at every forgetful use of the gas grill.

U.S. Pat. No. 6,289,792 to Grando, et al. discloses a whole barbecue with a cut-off valve built in requiring a preset condition by the user at every use. A mechanical clockwork timer unit is required to be set in conjunction with a single use of the cut-off valve operation. The cut-off valve additionally relies on a thermocouple installed at the burner area in its primary embodiment to burn fat off the grill. Typically the amount of time must be adjusted by the user for every use, depending on the amount of fat on the burner, or maybe guessing the time required depending on the type of meat cooked or the amount of total cooking time. Additionally, the cut-off valve is configured to open to a maximum, rapidly burning the fat as another objective of the invention.

### SUMMARY OF INVENTION

An object of the present invention is to provide a shut-off valve assuring that if an appliance is accidentally left on, it will be automatically shut off at every use without operator intervention or interaction. Another object of the present invention provides that the shut-off device can easily install and fit to a typical propane tank used in many outdoor gas grills. The shut-off valve fits between conventional industrial connectors used by propane tank and gas grill manufacturers. The installation procedure is unchanged from the typical grill supply line connection, fitting the portable shut-off valve between the tank and supply line, the body of the shut-off being sufficiently rigid to support the supply line and the overall length of the valve small enough for an easy fit. Once installed the shut-off valve stops flow of unwanted propane at every use.

Another object of the invention provides a means to adjust the time for which the appliance can stay on when and if the user neglectfully leaves appliance on. This feature the invention allows for flexibility in cooking times.

These and other objects are met by providing a low cost and portable automatic shut-off valve that easily fits to any common gas grill, guaranteeing conservation of fuel and safety at every use. Another object of the invention is, once activated; the invention can be manually reset with a button, allowing again full operation of the grill. The manual reset is in the spirit of the invention, since the operator that neglectfully left the gas grill on will not be able to re-light the grill until he resets the shut-off device, essentially reminding him of his misdeed, and hopefully preventing a repeat performance.

Other objects, advantages and salient features of the invention will become apparent from the following detailed description, which taken in conjunction with the annexed drawings, discloses preferred embodiments of the invention.

### BRIEF DESCRIPTION OF THE DRAWINGS

FIG. 1 is a perspective cross sectional view of this shutoff valve (open).

FIG. 2 is a perspective cross sectional view of this shutoff valve (closed).

FIG. 3 is a flow diagram showing sequence logic in the use of the invention.

### DETAILED DESCRIPTION OF THE INVENTION

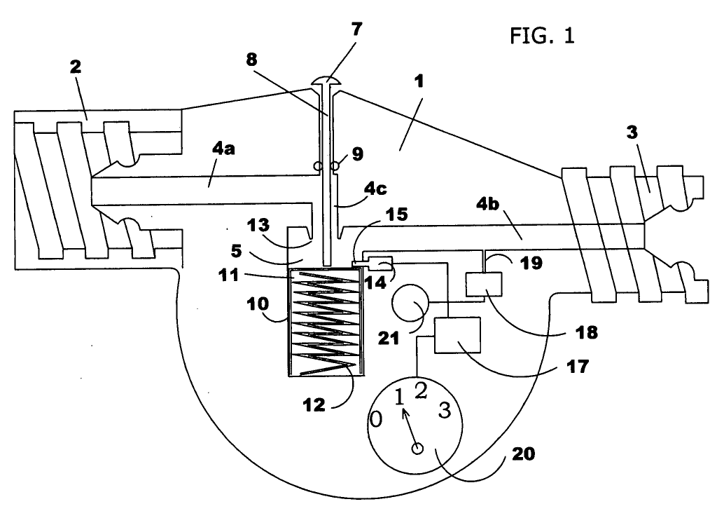

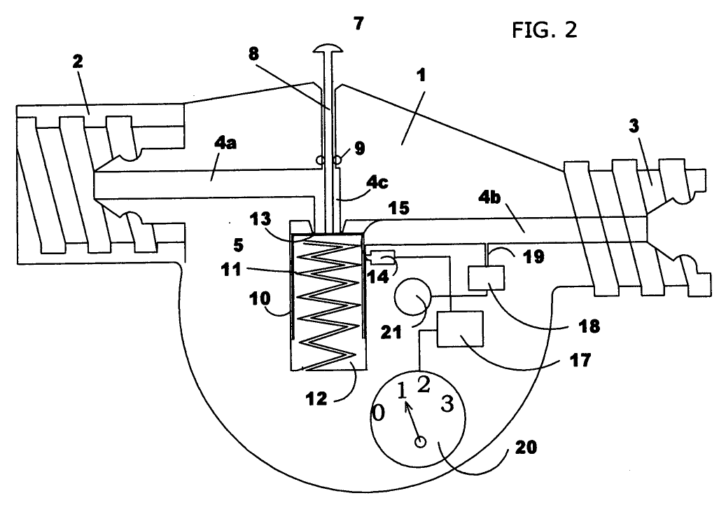

Turning to the FIG. 1, there is illustrated a shut-off valve in the spirit of the invention. A rigid valve body (1) has attached conventional fittings at either end, a female connector (2) and a male connector (3). Typically the female connector connects directly to a conventional propane tank, and the male connector connects directly to a standard gas grill supply line. In an alternate embodiment of the present invention, the shut-off valve may be incorporated directly to the control valve on a conventional propane tank. All connections use standard industrial threading providing ease of installation. Within the valve body there are bore passages, tank inlet (4a), appliance feed outlet (4b) and middle (4c) for the flow of gas. The bore passages connect continuously between the female connector and the male connector. Between the bore passages 4b & 4c is the flow chamber (5). Approximately perpendicular to the bore passages and aligned to the flow chamber is a plunger pin (6) and a reset button (7). The plunger pin is fitted inside the plunger bore (8) which contains a sealing o-ring (9). The plunger bore and o-ring provides for the lateral movement of the plunger pin whereas the plunger pin moves freely but seals preventing the escape of gas from the flow chamber. Directly opposite to the button plunger and button and centered and aligned with the plunger pin is a piston bore (10), a stopper piston (11), and a piston spring (12). Directly opposite to the piston and centered is a flow nozzle (13). In a preferred embodiment of the invention the plunger pin diameter allows for flow around it within the middle bore passage 4c and the flow nozzle. Another embodiment may allow for a smaller flow nozzle by supplying a return spring for the plunger pin lifting out and away from the flow nozzle. Approximately perpendicular to the piston and piston bore and positioned topmost in the piston bore is a release solenoid (14) functioning to prevent the piston from springing forward under the compression of the piston spring closing on the flow nozzle. In a preferred embodiment the solenoid is electrically activated to pull a release pin (15). Once activated, the solenoid pin releases the stopper piston from a compressed position (valve open). In the “valve open” position the piston spring is compressed pushing upwards sufficiently on the piston, whereas the piston then presses against the solenoid pin trapping it in a static position. Once the stopper piston is released it forcefully shuts and seals gas flow between the bore passages by pressing against the flow nozzle (13) which is directly opposite, center and aligned with the piston bore. Essentially the flow chamber is closed off. The solenoid action of pulling the solenoid pin is a temporary input; thusly the pin rests and is ready to be released from against the sidewall of the stopper piston as shown in FIG. 2 (valve closed). This described action is preceded by the end user pressing the reset button, thus moving the plunger pin against the stopper piston pushing it down into the piston bore releasing the solenoid pin from the sidewall of the stopper piston locking the stopper piston at the piston crown as shown in FIG. 1. The RESET action again allows gas to flow through the flow chamber.

An electronic timer (17) receives a signal from a pressure sensor (18) via a pressure measurement port (19). The pressure measurement port is positioned approximately in the appliance feed bore passage (4b) measuring either atmospheric pressure Pₐ (open position-static; barbecue not in use) or flow pressure P_{f} (open position-dynamic; barbecue in use—flow chamber pressure measured as P_{f)}. In a preferred embodiment of the invention, the timer connects to the solenoid, pressure sensor, and a timer selector control (20) and is electronically powered by a small battery (21) as shown in FIG. 1.

In the preferred embodiment of the invention, the timer counts down time from the initial flow through the shut-off valve (pressure sensor measures P_{f} which is greater than Pₐ), until ultimately it automatically shuts off, according to selection on the timer selection control. The timer selector control, in the preferred embodiment, allows for a user interface for incremental time adjustments, for example 0, 1, 2, 3 hours, where 0 hours is equivalent to nullification of shut-off valve operation. These settings allow for the flexibility in different cooking times to accommodate different foods.

In an alternative embodiment of the invention the pressure sensor and pressure measurement port could be replaced with a flow nozzle where differential pressures inside the nozzle trigger similar circuit responses. Another alternative embodiment of the invention replaces the pressures sensor and pressure measurement port with the flow gate positioned approximately in the appliance feed bore passage (4b) rotating to break an electronic connection when the gas is turned on, triggering the timer.

FIG. 2 illustrates the invention in the “CLOSED” position. In the preferred embodiment of the invention, the stopper button (7) is raised by the action of the stopper piston being released. The stopper piston seals off the gas at the flow nozzle (13) which in operation extinguishes the flame at the cooking grill or appliance. In the preferred embodiment of the invention the plunger pin moves with the stopper piston.

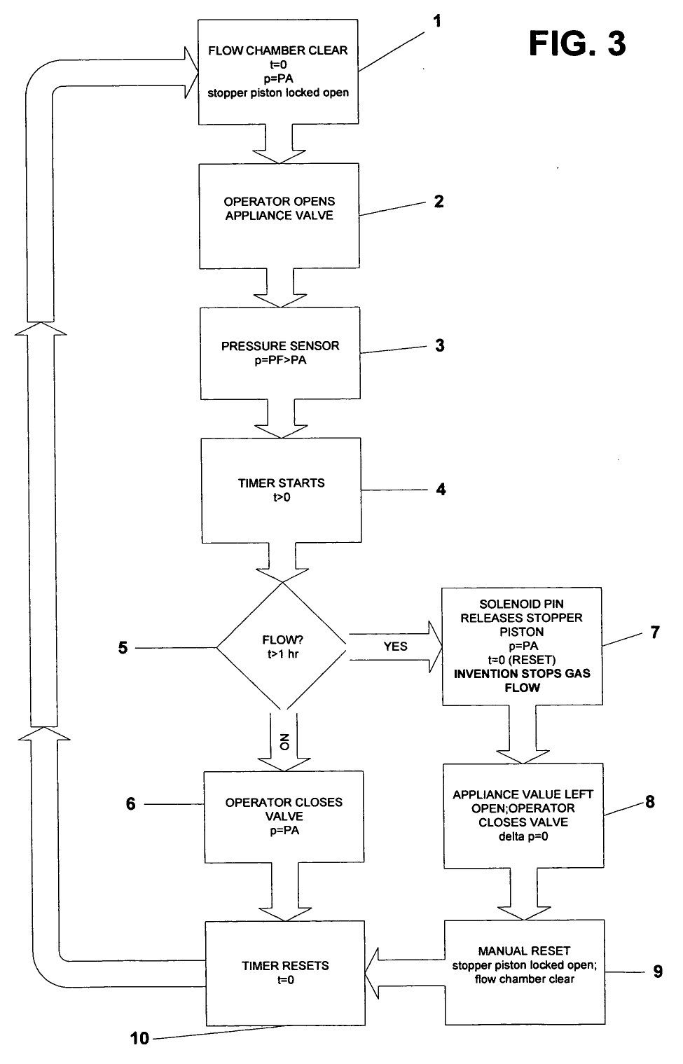

Turning to FIG. 3, there is illustrated a flow diagram of the invention. The flow diagram shows a typical sequential use and operation of the invention. Reading the flow diagram from top to bottom, box 1 represents the shut-off valve as open, the flow chamber is clear, time=zero, and piston is locked open as in FIG. 1. The pressure sensor reads the atmospheric pressure (P=Pa). The gas barbecue would be able to function normally. BOX 2, the operator commences the use of the appliance (for example a gas barbeque grill) and opens the appliance control valve (not shown on any illustration because of its common use). Next, Box 3 indicates the pressure sensor reads pressure P_{f} inside through the value as greater than atmospheric pressure Pₐ. In BOX 4 the timer is tripped by the pressure sensor signal and starts measuring the passage of time. This time represents the total time that the appliance will be on before the shut-off valve closes stopping the flow of gas. This limiting operation is preset by the user one time using the timer selector control (20 on FIG. 1). BOX 5 represents a decision point whether enough time (t>1 hour for example) has passed requiring the shut-off of gas. In a preferred embodiment of the invention, the shut-off valve circuitry requires little or no power until activated to shut-off. Once in use and the timer trips, momentarily actuating the solenoid pin back to release the stopper piston as illustrated in BOX 7. The power required is minimal and transitory since the solenoid pin is rapidly released and then rests against the sidewall of the stopper piston. Continuing from BOX 5, if the limiting time t<1 hour (for example) the operator can use the appliance and properly shutting down the appliance valve as represented in BOX 6. Under these conditions the normal operating use of the gas appliance is unimpeded without need for any additional user input. The appliance is ready for use next time, operating normally without user intervention, allowing the invention to actively monitor gas flow at the next use. The pressure sensor again measures atmospheric (Pa) (since the appliance control valve is closed) and signals the timer to reset t=0 (BOX 10).

Under a different decision scenario, BOX 7 shows the appliance has been left on longer than allowable set duration of time (limiting operation set, for example 1 hour), and thus, the stopper piston is released shutting off gas flow in the float chamber and ultimately to the appliance. Additionally, the logic circuit resets the timer to zero (t=0), and the shut-off valve timer circuit is ready for the next time. BOX 8 represents in the user scenario that condition whereas the user returns to the appliance noticing that the appliance gas operation valve is open, and closes it. BOX 9 in the flow diagram the user would be required to push the RESET button on the shut-off valve to make operable the appliance again. The RESET button locks the stopper piston down as in FIG. 1 with the solenoid pin holding the piston open clearing the flow chamber. In the spirit of the invention, the manual reset reminds the user such a trip condition has occurred. In an embodiment of the invention the raised reset button (as in FIG. 2) is a visual indicator. In other embodiments of the invention the visual indication may be enhanced with colored indicators.

Although the invention has been described in conjunction with specific embodiments, it is evident that many alternatives and variations will be apparent to those skilled in the art in light of the foregoing description.

In an alternate embodiment the electronics can be replaced with a pressure actuated clockworks whereas said flow pressure P_{f} works on a mechanical bellows to preload the clockworks that pulls the release pin (15) after the set duration of time.

Another embodiment similar to the previous replaced the pressure loading mechanical bellows with a mechanical system of levers and gears working in conjunction with appliance operator valve, so that once the appliance is used the said clockworks is preloaded.

Accordingly, the invention is intended to embrace all of the alternatives and variations that fall within the spirit and scope of the appended claims.

I claim:

1) A self closing valve comprising: sensor means for sensing operating conditions to close and cut off gas flow to an appliance;
A valve body comprising male and female connections fitted to connect inline between a supply and feed connection to said appliance allowing contiguous gas flow;
A flow nozzle and flow stopper piston with means for releasing and closing on said flow nozzle stopping gas flow from supply to feed connections when said operating conditions are met;
Processing means for determining a relationship between the sensed operating condition and a preset operating limit;
Limiting means for setting the preset operating limit;
A re-setting means for actuation of said flow stop piston to the pre-release position.

2) Valve according to claim 1, wherein said gas flow is stopped by a plugging gate translating diagonal or rotating about an axle centered in flow orifice.

3) Valve according to claim 1, wherein said processing means comprises an electronic circuitry for determining said sensed operating condition and the preset operating limit.

4) Electronic circuitry according to claim 3 comprising; a pressure sensor, timer, selector gauge and power source controlling the actuation of a release solenoid; said release solenoid provides the means of release on said flow stopper piston and said pressure sensor providing said sensor means of changing flow pressure in the valve body.

5) Valve according to claim 1, wherein said re-setting means comprises a re-set button on top of a plunger pin when manually actuated presses said stopper piston to a re-set position that corresponds to said release position; said plunger pin sealed by an o-ring in valve body and passes center through said flow nozzle acting on the stopper piston with proper clearance to provide sufficient flow at flow nozzle and resting atop stopper piston in an open and said pre-release position.

6) Valve according to claim 1 configured into a conventional propane tank control valve.

7) Electronic circuitry according to claim 4, wherein said pressure sensor is replaced by a flow restricting actuator that opens sensing gas or liquid flow providing an electronic signal to said processing means.

8) Valve according to claim 1, wherein said processing means comprises mechanical clockworks using a mechanical system of levers and gears to preloads said clockworks as the appliance is manually turned on; said clockworks at said limiting condition releases said stopper piston by pulling said release pin.

9) Valve according to claim 8 wherein said clockworks is preloaded by a pressurized mechanical bellows using the pressure of said gas supply.

10) Re-setting means according to claim 5, wherein said plunger pin and said button returns after actuation to a static position via a return spring.

11) Re-setting means according to claim 5, wherein said plunger pin and said reset button are replaced with a functional corresponding mechanic lever, switch, or crank or electronic actuated re-setting solenoid that actuates through said flow nozzle or adjacent to pushing directly or indirectly on flow stopper piston to said pre-release position.

12) Re-setting means according to claim 5, wherein said re-set button is replaced by an automatic re-setting means using a pressure or electronic feedback from said appliance controlling valve to a pressure or electric re-setting solenoid moving on said plunger pin.

13) Valve according to claim 1, wherein said valve body has threaded connections to fit inline to a standard natural gas line.
